(19) United States
(12) Patent Application Publication
(10) Pub. No.: US 2026/0328625 A1
(43) Pub. Date: Oct. 22, 2026

(54) METHOD, DEVICE AND SYSTEM FOR DETECTING FAULT IN BUSWAY

(71) Applicant: Schneider Electric Industries SAS, Rueil-Malmaison (FR)

(72) Inventors: Jingran ZHANG, Shanghai (CN); Jianyuan HUANG, Shanghai (CN); Xia WU, Shanghai (CN); Jingtong CHEN, Shanghai (CN)

(21) Appl. No.: 19/648,163

(22) Filed: Apr. 15, 2026

(30) Foreign Application Priority Data
Apr. 18, 2025 (CN) 2025104950995

(51) Int. Cl. G01K 3/14

(52) U.S. Cl. CPC G01K 3/14; G01K 2003/145

(57) ABSTRACT

A method, a device and a system for detecting a fault in a busway are provided. According to the embodiments of the present invention, the measured temperature at each of a plurality of measurement points at any time point can be obtained, and by laterally comparing the measured temperatures at the plurality of measurement points at this time point based on the position order of the plurality of measurement points, a fault occurrence can be detected at each measurement point in real time without a presence of a current at the measurement point. Therefore, a health status of the busway could be monitored in real time both when the busway is in a full load operation and in a non-full load operation.

### CROSS-REFERENCE

This application claims priority to Chinese Patent Application No. 2025104950995, filed Apr. 18, 2025, and entitled METHOD, DEVICE AND SYSTEM FOR DETECTING FAULT IN BUSWAY, the entirety of which is incorporated herein by reference.

### TECHNICAL FIELD

The present invention relates to device fault detection, and more specifically, to a method, device and system for detecting a fault in a busway.

### BACKGROUND

Vast majority of faults in a busway are caused by excessive temperature rise of conductors and a failure of insulation materials. The current detection methods include a non-intrusive monitoring scheme and a non-intrusive monitoring scheme. The non-intrusive monitoring scheme will make an alarm only after the fault occurs, and it will not even make the alarm in a low load state. The intrusive monitoring scheme may destroy structure integrity of the busway. In addition, the fault alarm depends on an upper limit of safe temperature rise, but whether the state of the busway is normal cannot be determined in the low load state. Moreover, a temperature measurement of a housing h as hysteresis, and it is impossible to monitor temperature rise of a low load where a current cannot be measured.

Therefore, there is a need for a busway fault detection scheme that could be applied in various load states.

### SUMMARY

According to an embodiment of the present invention, there is provided a method for detecting a fault on a busway, including: obtaining a plurality of respective measured temperatures corresponding to a plurality of measurement points on a busway; comparing the plurality of measured temperatures based on a position order of the plurality of measurement points; and determining whether a fault occurs at the plurality of measurement points based on a result of the comparison.

In an example, the comparing the plurality of measured temperatures includes: determining whether each of the plurality of measured temperatures satisfies a predetermined temperature relationship of the plurality of measurement points based on the position order of the plurality of measurement points.

In an example, the determining whether a fault occurs at the plurality of measurement points based on the result of the comparison includes, for each of the plurality of measured temperatures: determining that a measurement point corresponding to the measured temperature is normal when the measured temperature satisfies the predetermined temperature relationship; and determining whether a difference between the measured temperature and a measured temperature of a previous adjacent measurement point is within a standard temperature threshold when the measured temperature does not satisfy the predetermined temperature relationship.

In an example, when the difference between the measured temperature and the measured temperature of the previous adjacent measurement point is within the standard temperature threshold, it is determined that the measurement point corresponding to the measured temperature is normal, and when the difference between the measured temperature and the measured temperature of the previous adjacent measurement point exceeds the standard temperature threshold, it is determined that the fault occurs at the measurement point corresponding to the measured temperature.

In an example, the standard temperature threshold is determined based on a type of a component at the measurement point corresponding to the measured temperature.

In an example, the method further includes: receiving a topology diagram o the busway, wherein the topology diagram of the busway includes information on the position order of the plurality of measurement points and types of components at the measurement points.

In an example, the busway is in a full load operation or a non-full load operation.

In an example, the comparing the plurality of measured temperatures includes: determining a highest temperature among the plurality of measured temperatures; and comparing the highest temperature with measured temperatures of a plurality of adjacent measurement points of a measurement point corresponding to the highest temperature, based on a position order of the plurality of adjacent measurement points of the measurement point corresponding to the highest temperature.

In an example, the determining whether the fault occurs at the plurality of measurement points based on the result of the comparison includes: determining whether the fault occurs at the measurement point corresponding to the highest temperature based on the result of the comparison.

In an example, the method further includes: determining a working scene of plurality of measurement points; and determining a scene-specific temperature threshold based on the working scene.

In an example, the comparing the highest temperature with the measured temperatures of a plurality of adjacent measurement points of the measurement point corresponding to the highest temperature based on the position order of the plurality of adjacent measurement points of the measurement point corresponding to the highest temperature includes: determining whether the highest temperature satisfies a predetermined temperature relationship of the plurality of adjacent measurement points.

In an example, the determining whether the fault occurs at the measurement point corresponding to the highest temperature based on the result of the comparison includes: determining that the measurement point corresponding to the highest temperature is normal when the highest temperature satisfies the predetermined temperature relationship of the plurality of adjacent measurement points; and determining whether a difference between the highest temperature and a measured temperature of a previous adjacent measurement point is within a scene-specific temperature threshold when the highest temperature does not satisfy the predetermined temperature relationship of the plurality of adjacent measurement points.

In an example, when the difference between the highest temperature and the measured temperature of the previous adjacent measurement point is within the scene-specific temperature threshold, it is determined that the measurement point corresponding to the highest temperature is normal, and when the difference between the highest temperature and the measured temperature of the previous adjacent measurement point exceeds the scene-specific temperature threshold, it is determined that the fault occurs at the measurement point corresponding to the highest temperature.

In an example, the working scene includes one or more of a wall-penetrating scene, a non-ventilation scene and a ventilation scene, and wherein a scene-specific temperature threshold of the wall-penetrating scene is higher than a scene-specific temperature threshold of the non-ventilation scene, and the scene-specific temperature threshold of the non-ventilation scene is higher than a scene-specific temperature threshold of the ventilation scene.

In an example, the plurality of adjacent measurement points include a first plurality of previous measurement points and a second plurality of subsequent measurement points.

According to another embodiment of the present invention, there is provided a device for detecting a fault in a busway, including: a memory; and a processor coupled with the memory and configured to perform any of the aforementioned methods.

According to yet another embodiment of the present invention, there is provided a system for detecting a fault in a busway, including: a plurality of sensors arranged at each measurement point of a busway and configured to measure temperatures of the corresponding measurement points; a transceiver configured to transmit and receive signals; a memory; and a processor coupled with the plurality of sensors, the transceiver and the memory and configured to perform any of the aforementioned methods.

Therefore, according to the embodiments of the present invention, the measured temperature at each measurement point at any time point can be obtained, and by laterally comparing the measured temperatures at the plurality of measurement points at this time point based on the position order of the plurality of measurement points, it could determine whether the fault occurs at each measurement point in real time without a presence of a current at the measurement point. Therefore, a health status of the busway could be monitored in real time in both case that the busway is in a full load operation and in a non-full load operation.

### BRIEF DESCRIPTION OF THE DRAWINGS

The present invention will be more easily understood through the following detailed description with the help of the accompanying drawings, in which the same reference numerals designate units of the same structure, and in which:

FIG. 1 is a schematic flowchart illustrating a method for detecting a fault a busway according to an embodiment of the present invention;

FIG. 2 illustrates a schematic diagram of joint arrangements on a busway according to an embodiment of the present invention;

FIG. 3 is a schematic flowchart illustrating a method for detecting a fault in a busway according to another embodiment of the present invention;

FIG. 4 is a schematic diagram illustrating a result of detecting a fault in a busway based on scene identification according to an embodiment of the present invention;

FIG. 5 is a schematic block diagram illustrating a device for detecting a fault in a busway according to an embodiment of the present invention; and

FIG. 6 is a schematic block diagram illustrating a system for detecting a fault in a busway according to an embodiment of the present invention.

### DETAILED DESCRIPTION

The technical scheme in the embodiments of the present invention will be clearly and completely described below with reference to the drawings in the embodiments of the present invention. Obviously, the described embodiments are a part of the embodiments of the present invention, but not all of the embodiments. Based on the embodiments in the present invention, all other embodiments obtained by a person of ordinary skill in the art without inventive effort belong to the scope of protection of the present invention.

Furthermore, it should be noted that in the specification, A connected to may mean “A directly connected to B” or “A connected to B via other middleware.” A connected between B and C may mean “A directly connected to A and B” or “A connected to B and C via other middleware.”

FIG. 1 is a schematic flowchart illustrating a method 100 for detecting a fault in a busway according to an embodiment of the present invention.

As shown in FIG. 1, at 101 of the method 100, a plurality of respective measured temperatures corresponding to a plurality of measurement points on a busway may be obtained. At 102, the plurality of measurement temperatures are compared based on a position order of the plurality of measurement points. At 103, whether a fault occurs at the plurality of measurement points may be determined based on a result of the comparison.

Therefore, according to the embodiments of the present invention, the measured temperature at each measurement point at any time point can be obtained, and by laterally comparing the measured temperatures at the plurality of measurement points at this time point based on the position order of the plurality of measurement points, it could determine whether the fault occurs at each measurement point in real time without a presence of a current at the measurement point. Therefore, a health status of the busway could be monitored in real time in both case that the busway is in a full load operation and in a non-full load operation.

The scheme according to the embodiment of the present invention may determine whether the fault occurs at the respective measurement points only by comparing the temperatures of each measurement point measured at the current time.

In addition, the scheme according to the embodiment of the present invention does not need to measure a current signal of each measurement point, and could determine whether the fault occurs at the measurement point without obtaining the current signal or in a case of no a current signal.

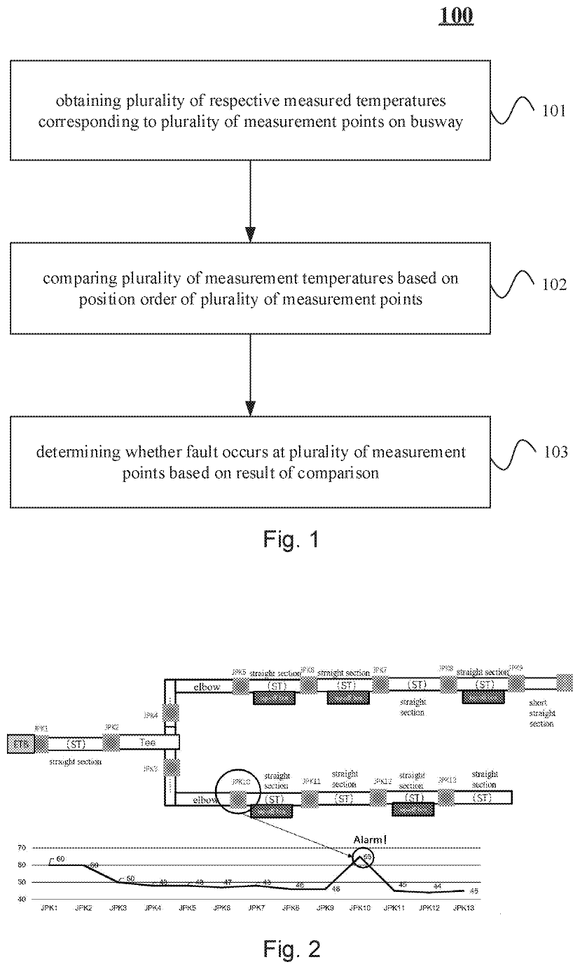

Next, a process of the method for detecting the fault in the busway according to the embodiment of the present invention will be described in detail with reference to FIG. 2.

FIG. 2 illustrates a schematic diagram of joint arrangements on a busway according to an embodiment of the present invention.

As shown in FIG. 2, according to the embodiment of the present invention, measurement points on a busway may include joints on the busway, for example, joints at Tees (Tee sections) and tap-off boxes. However, the embodiment of the present invention is not limited thereto, and those skilled in the art can understand that the measurement points may also include points at other positions on the busway. For simplicity of description, the embodiments of the present invention will be described in detail with the joints at the Tees and tap-off boxes as examples of measurement points.

In an example, a temperature of each measurement point may be measured by a sensor arranged at each of a plurality of measurement points.

For example, the temperatures of the plurality of measurement points may include temperatures of a joint JPK1, a joint JPK2, a joint JPK3, a joint JPK4, a joint JPK5, a joint JPK6, a joint JPK7, a joint JPK8, a joint JPK9, a joint JPK10, a joint JPK11, a joint JPK12 and a joint JPK13.

Although 13 measurement points are shown in FIG. 2, those skilled in th art can understand that the number of measurement points may be more or less.

At 102, the comparing the plurality of measured temperatures may include determining whether each of the plurality of measured temperatures satisfies a predetermined temperature relationship of the plurality of measurement points based on a position order of the plurality of measurement points.

The predetermined temperature relationship of the plurality of measurement points is based on the position order of the plurality of measurement points.

The Tee sections and the tap-off boxes have a function of diverting a current, which means that for each Tee section and each tap-off box, a current before it may usually be greater than a current after it. In the whole busway system, due to the current diversion of the joints such as the joints at the tap-off boxes and Tee sections, based on a current direction, a temperature in the same environment (for example, at a factory building and corridor) in each loop is basically the same and a temperature of a front joint is usually higher than or equal to a temperature of a rear joint along the current direction,.

In an example, the predetermined temperature relationship of the plurality of measurement points may indicate that the temperatures of the plurality of measurement points decrease in order. However, those skilled in the art can understand that the embodiment of the present invention is not limited thereto, and the predetermined temperature relationship of the plurality of measurement points may also indicate that the temperatures of the plurality of measurement points increase in order according to an operating state of the busway and a position where each joint is arranged, and so on.

For example, in the arrangement shown in FIG. 2, the predetermined temperature relationship of the plurality of measurement points may indicate that the temperatures of the joint JPK1, the joint JPK2, the joint JPK3, the joint JPK4, the joint JPK5, the joint JPK6, the joint JPK7, the joint JPK8, the joint JPK9, the joint JPK10, the joint JPK11, the joint JPK12 and the joint JPK13 decrease in order.

That is, the predetermined temperature relationship of the plurality of measurement points may be expressed as T_{JPKn}≤T_{JPKn-1}, where T_{JPKn} represents a measured temperature of an n-th joint and T_{JPKn-1} represents a measured temperature of an (n−1)-th joint before the n-th joint.

At 103, whether the fault occurs at the plurality of measurement points may be determined based on the result of the comparison. In an example, for each of the plurality of measured temperatures: when the measured temperature satisfies the predetermined temperature relationship, it may be determined that the measurement point corresponding to the measured temperature is normal, and when the measured temperature does not satisfy a temperature change prediction, it may be determined whether a difference between the measured temperature and a measured temperature of a previous adjacent measurement point is within a standard temperature threshold.

For example, for the measured temperature T_{JPKn}, if it is not higher than T_{JPKn-1}, it may be determined that the measured temperature T_{JPKn} satisfies the predetermined temperature relationship of the plurality of measurement points, so that it may be determined that the measurement point corresponding to the measured temperature T_{JPKn}, that is, the joint JPKn, is normal.

If the measured temperature T_{JPKn} is higher than T_{JPKn-1}, the difference between the measured temperature and the measured temperature of the previous adjacent measurement point may be calculated. For example, a difference between T_{JPKn} and T_{JPKn-1} may be calculated.

In an example, when the difference between the measured temperature and the measured temperature of the previous adjacent measurement point is within the standard temperature threshold, it is determined that the measurement point corresponding to the measured temperature is normal, and when the difference between the measured temperature and the measured temperature of the previous adjacent measurement point exceeds the standard temperature threshold, it is determined that the fault occurs at the measurement point corresponding to the measured temperature.

The standard temperature threshold Th_{general} may be a value preset by a system or a user in advance, and may be the same value or a different value for each measurement point. For example, the standard temperature threshold may be in degrees Celsius (C) or Kelvin (K).

In an example, the standard temperature threshold Th_{general} may be determined based on a type of a component at the measurement point corresponding to the measured temperature. For example, for elbows and short straight sections as shown in FIG. 2, the standard temperature threshold Th_{general} may be 3 °C or 3K, and for other types of components, such as long straight sections, the standard temperature threshold Th_{general} may be 5 °C or 5K. However, those skilled in the art should understand that the value of the standard temperature threshold Th_{general} is not limited to the specific examples described here.

For example, in the example shown in FIG. 2, T_{JPK10}=65 °C, T_{JPK9}=46 °C, and when the standard temperature threshold Th_{general} is 5 °C, it may be determined that the fault occurs at the joint JPK10.

If it is determined that the fault occurs at the joint, the method 100 according to the embodiment of the present invention may make an alarm, for example, a visual and/or an audible alarm may be issued through a display (not shown) or a speaker (not shown) to inform the user that there is a joint fault and indicate a position of the joint.

In an example, the method 100 may further include receiving a topology diagram of the busway. The topology diagram of the busway may include information on the position order of the plurality of measurement points and types of components at the measurement points. The topology diagram of the busway may be received before step 101 or step 102, or the topology diagram of the busway may be received in parallel with step 101 or step 102.

In an example, the busway may be in a full load operation state and in a non-full load operation state. The non-full load operation state may include all low load operation states.

Therefore, the scheme for detecting the fault in the busway according to the embodiment of the present invention could make an early warning for the busway in the full load operation and the non-full load operation, especially in the low load operation, and inform a customer of the busway fault in advance, and has strong universality and wide application, and can be extended to most busway platforms (Track, I Line II, etc.) and various types of busways, so as to realize monitoring of the health status of the whole busway system and realize the low load alarm even for some points with no current.

In a practical application, the busway may be arranged in various scenes, for example, one or more of a wall-penetrating scene, a non-ventilation scene and a ventilation scene. The temperatures of the measurement point measured in various scenes may be different, and there may be a case where a difference between measured temperatures of two measurement points in a certain scene is high. In this case, a scene-specific temperature threshold based on the scene may be applied instead of the standard temperature threshold.

In an example, a downstream busway may be arranged in the same scene, and an upstream busway may be arranged in different scenes or in the same scene.

Those skilled in the art should understand that although the wall-penetrating scene, the non-ventilation scene and the ventilation scene are described here as examples of scenes, the embodiment of the present invention is not limited thereto, and there may be more or less scenes.

In an example, a working scene of the plurality of measurement points may be determined, and the scene-specific temperature threshold may be determined based on the working scene.

In an example, a scene-specific temperature threshold of the wall-penetrating scene may be higher than a scene-specific temperature threshold of the non-ventilation scene, and the scene-specific temperature threshold of the non-ventilation scene may be higher than a scene-specific temperature threshold of a ventilation scene.

The scene-specific temperature threshold may give an additional temperature redundancy for each scene.

In an example, a scene-specific temperature threshold for each scene may be preset, for example, the scene-specific temperature threshold of the wall-penetrating scene, the scene-specific temperature threshold of the non-ventilation scene and the scene-specific temperature threshold of the ventilation scene may be preset as Th_A, Th_B and Th_C, respectively, where Th_A, Th_B and Th_C are positive numbers and may be the same as or different from each other.

For example, the scene-specific temperature threshold of the wall-penetrating scene may be preset to 10 °C or 10K, the scene-specific temperature threshold of the non-ventilation scene may be preset to 8 °C or 8K, and the scene-specific temperature threshold of the ventilation scene may be equal to the standard temperature threshold, that is, 5 °C or 5K. However, those skilled in the art should understand that the numerical values of the scene-specific temperature thresholds Th_A, Th_B and Th_C are not limited to the specific examples described here.

In addition, the scene-specific temperature threshold of each scene may also be preset in the form of a bias value. In an example, the scene-specific temperature threshold may be preset in the form of a bias value relative to the standard temperature threshold Th_{general}.

For example, based on each scene, the bias values of the scene-specific temperature threshold of the wall-penetrating scene, the scene-specific temperature threshold of the non-ventilation scene and the scene-specific temperature threshold of the ventilation scene relative to the standard temperature threshold Th_{general} may be preset as Th_bia1, Th_bia2 and Th_bia3, respectively, and Th_bia1, Th_bia2 and Th_bia3 may be positive numbers, negative numbers or 0, and may be the same as or different from each other.

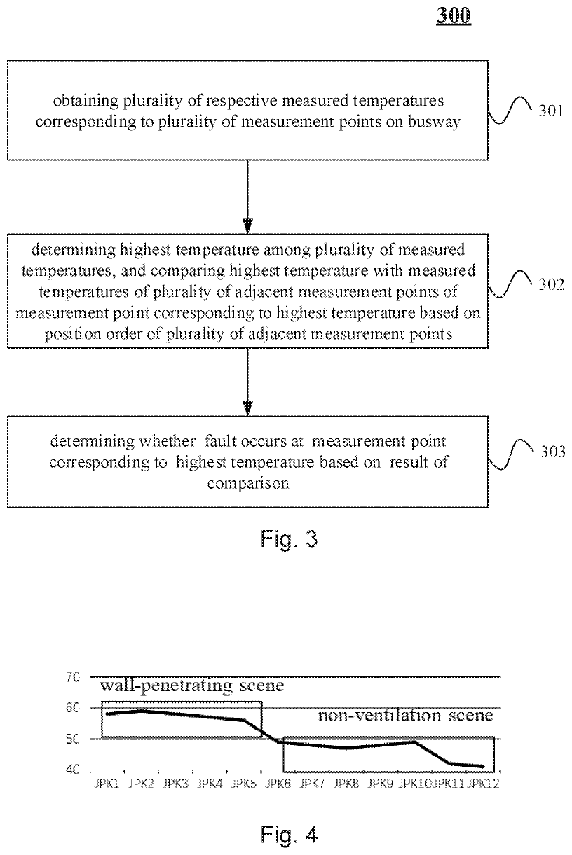

FIG. 3 is a schematic flowchart illustrating a method 300 for detecting a fault in a busway according to another embodiment of the present invention.

As shown in FIG. 3, at 301 of the method 300, a plurality of respective measured temperatures corresponding to a plurality of measurement points on a busway may be obtained. At 302, a highest temperature among the plurality of measured temperatures is determined, and the highest temperature may be compared with measured temperatures of a plurality of adjacent measurement points of a measurement point corresponding to the highest temperature based on a position order of the plurality of adjacent measurement points. At 303, whether a fault occurs at the measurement point corresponding to the highest temperature may be determined based on a result of the comparison.

A topology diagram of the busway may be received before step 301 or step 302, or the topology diagram of the busway may be received in parallel with step 301 or step 302.

Step 302 may correspond to step 102 of the method 100 and step 303 m correspond to step 103.

The method 300 may be performed for an upstream busway during busway system initialization, and the method 100 may be performed for a downstream busway.

In an example, the plurality of adjacent measurement points may include first plurality of previous measurement points and a second plurality of subsequent measurement points. The first plurality of previous measurement points may include a plurality of measurement points, for example, 10 measurement points. before the measurement point corresponding to the highest temperature in a topological order of the busway, and the second plurality of subsequent measurement points may include a plurality of measurement points, for example, 10 measurement points, after the measurement point corresponding to the highest temperature in the topological order of the busway.

A number of the first plurality of previous measurement points and a number of the second plurality of subsequent measurement points are not limited thereto.

At 302, the comparing the highest temperature with the measured temperatures of the plurality of adjacent measurement points of the measurement point corresponding to the highest temperature based on the position order of the plurality of adjacent measurement points may include: determining whether the highest temperature satisfies the predetermined temperature relationship of the plurality of adjacent measurement points.

Similar to that described above with reference to FIG. 1, the predetermined temperature relationship of the plurality of adjacent measurement points may also indicate that the temperatures of the plurality of adjacent measurement points decrease in order. However, those skilled in the art can understand that the embodiment of the present invention is not limited thereto, and the predetermined temperature relationship of the plurality of adjacent measurement points may also indicate that the temperatures of the plurality of adjacent measurement points increase in order according to an operating state of the busway and a position where each joint is arranged, and so on.

At 303, the determining whether the fault occurs at the measurement point corresponding to the highest temperature based on the result of the comparison may include: determining that the measurement point corresponding to the highest temperature is normal when the highest temperature satisfies the predetermined temperature relationship of the plurality of adjacent measurement points; and determining whether a difference between the highest temperature and a measured temperature of a previous adjacent measurement point is within a scene-specific temperature threshold when the highest temperature does not satisfy the predetermined temperature relationship of the plurality of adjacent measurement points.

Here, as mentioned above, the predetermined temperature relationship of the plurality of adjacent measurement points is based on a position order of the plurality of adjacent measurement points and the measurement point corresponding to the highest temperature.

The process of determining whether the fault occurs at the measurement point corresponding to the highest temperature at step 303 is similar to the process of determining whether the fault occurs at the plurality of measurement points at step 103.

Specifically, when the difference between the highest temperature and the measurement temperature of the previous adjacent measurement point is within the scene-specific temperature threshold, it is determined that the measurement point corresponding to the highest temperature is normal, and when the difference between the highest temperature and the measurement temperature of the previous adjacent measurement point exceeds the scene-specific temperature threshold, it is determined that the fault occurs at the measurement point corresponding to the highest temperature.

According to the embodiment of the present invention, through a scene identification, whether the fault occurs at the measurement point may be determined based on the scene-specific temperature threshold, so that the over-temperature false alarm can be avoided, the accuracy of monitoring and early warning is improved, and the operation and maintenance workload for the client is reduced.

In addition, the scheme according to the embodiment of the present invention does not need to measure a current signal of each measurement point, and can determine whether the fault occurs at the measurement point without obtaining the current signal or in a case of no current signal.

FIG. 4 is a schematic diagram illustrating a result of detecting a fault in a busway based on a scene identification according to an embodiment of the present invention.

As shown in FIG. 4, the joint JPK1, the joint JPK2, the joint JPK3, the joint JPK4 and the joint JPK5 are identified as being in the wall-penetrating scene, and the joint JPK6, the joint JPK7, the joint JPK8, the joint JPK9, the joint JPK10, the joint JPK11 and the joint JPK12 are identified as being in the non-ventilation scene.

A measured temperature of the joint JPK10 is determined as a highest temperature. Without the application of the scene identification, it may be determined that a fault occurs at the joint JPK10.

However, according to the embodiment of the present invention, the joint JPK10 is identified as being in the non-ventilation scene, with a scene-specific temperature threshold higher than a standard temperature threshold. Therefore, it may be determined that a difference between the measured temperature of the joint JPK10 and a measured temperature of the joint JPK9 is lower than the scene-specific temperature threshold, so it may still be determined that the joint JPK10 is normal, thus avoiding the false alarm.

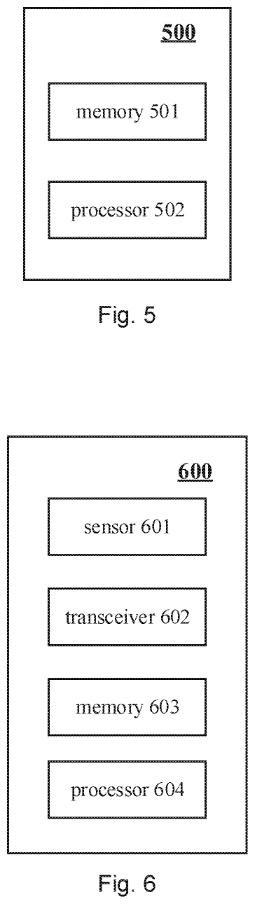

FIG. 5 illustrates a schematic block diagram of a device 500 for detecting a fault in a busway according to an embodiment of the present invention.

As shown in FIG. 5, the device 500 may include a memory 501 and a processor 502. The memory 501 may store various data required by the device 500, and the processor 502 is coupled with the memory 501 and configured to perform the methods described above with reference to FIGS. 1 and 3.

FIG. 6 illustrates a schematic block diagram of a system 600 for detecting a busway fault according to an embodiment of the present invention.

As shown in FIG. 6, the system 600 may include a plurality of sensors 601, a transceiver 602, a memory 603 and a processor 604.

The plurality of sensors 601 may be arranged at the each measurement point of the busway and configured to measure the temperature of the corresponding measurement point. The transceiver 602 may be configured to transmit and receive signals. The memory 603 may store various data required by the system 600. The processor 604 is coupled with the plurality of sensors 601, the transceiver 602 and the memory 603, and is configured to perform the methods described above with reference to FIGS. 1 and 3.

Although it is shown in FIGS. 1 and 3 that the respective steps are performed in order, those skilled in the art can understand that the method 100 and the method 300 can be performed in an order other than that shown in the figures without departing from the teachings of the embodiments of the present invention.

A person of ordinary skill in the art can realize that the units and algorithm steps of each embodiment described in connection with the embodiments disclosed in the present invention can be implemented by electronic hardware, computer software or a combination of the two. In order to clearly illustrate the interchangeability of hardware and software, the components and steps of each embodiment have been generally described according to functions in the above description. Whether these functions are performed in hardware or software depends on the specific application and design constraints of the technical scheme. Skilled people can use different methods to realize the described functions for each specific application, but such realization should not be considered beyond the scope of the present invention.

It can be clearly understood by those skilled in the art that for the convenience and conciseness of description, the specific working processes of the systems, devices and units described above can refer to the corresponding processes in the aforementioned method embodiments, and will not be repeated here.

In several embodiments provided by the present invention, it should be understood that the disclosed systems, devices and methods can be implemented in other ways. For example, the device embodiment described above is only schematic. For example, the division of the units is only a logical function division. In actual implementation, there may be other division methods, for example, multiple units or components can be combined or integrated into another system, or some features can be ignored or not performed. On the other hand, the mutual coupling or direct coupling or communication connection shown or discussed can be indirect coupling or communication connection through some interfaces, devicees or units, which can be electrical, mechanical or other forms.

The units described as separate parts may or may not be physically separated, and the parts displayed as units may or may not be physical units, which may be located in one place or distributed to multiple network units. Some or all of the units can be selected according to actual requirements to achieve the purpose of the embodiments.

In addition, each functional unit in each embodiment of the present invention may be integrated into one processing unit, or each unit may exist physically alone, or two or more units may be integrated into one unit. The above integrated units can be implemented in the form of hardware or software functional units.

The integrated units can be stored in a computer-readable storage medium if they are implemented in the form of software functional units and sold or used as independent products. Based on this understanding, the technical solution of the present invention essentially or a part thereof that contributes to the prior art or in whole or in part can be embodied in the form of a software product, which is stored in a storage medium and includes several instructions to cause a computer device (which may be a personal computer, a server, or a network device, etc.) to perform all or part of the steps of the methods described in various embodiments of the present invention. The aforementioned storage medium includes: U disk, mobile hard disk, Read-Only Memory (ROM), Random Access Memory (RAM), magnetic disk or optical disk and other media that can store program codes.

The above descriptions are only the specific implementations of the present invention, but the scope of protection of the present invention is not limited thereto. Any person familiar with the technical field can easily think of changes or substitutions within the technical scope disclosed by the present invention, which should be included in the scope of protection of the present invention. Therefore, the scope of protection of the present invention should be based on the scope of protection of the claims.

What is claimed is:

1. A method for detecting a fault in a busway, comprising:
obtaining a plurality of respective measured temperatures corresponding to a plurality of measurement points on a busway;
comparing the plurality of measured temperatures based on a position order of the plurality of measurement points; and
determining whether a fault occurs at the plurality of measurement points based on a result of the comparison.

2. The method of claim 1, wherein the comparing the plurality of measured temperatures comprises:
determining whether each of the plurality of measured temperatures satisfies a predetermined temperature relationship of the plurality of measurement points based on the position order of the plurality of measurement points.

3. The method of claim 2, wherein the determining whether the fault occurs at the plurality of measurement points based on the result of the comparison comprises, for each of the plurality of measured temperatures:
determining that a measurement point corresponding to the measured temperature is normal when the measured temperature satisfies the predetermined temperature relationship; and
determining whether a difference between the measured temperature and a measured temperature of a previous adjacent measurement point is within a standard temperature threshold when the measured temperature does not satisfy the predetermined temperature relationship.

4. The method of claim 3, wherein when the difference between the measured temperature and the measured temperature of the previous adjacent measurement point is within the standard temperature threshold, it is determined that the measurement point corresponding to the measured temperature is normal, and
when the difference between the measured temperature and the measured temperature of the previous adjacent measurement point exceeds the standard temperature threshold, it is determined that the fault occurs at the measurement point corresponding to the measured temperature.

5. The method of claim 4, wherein the standard temperature threshold is determined based on a type of a component at the measurement point corresponding to the measured temperature.

6. The method of claim 2, further comprising:
receiving a topology diagram of the busway,
wherein the topology diagram of the busway comprises information on the position order of the plurality of measurement points and types of components at the measurement points.

7. The method of claim 1, wherein the busway is in a full load operation or a non-full load operation.

8. The method of claim 6, wherein the comparing the plurality of measured temperatures comprises:
determining a highest temperature among the plurality of measured temperatures; and
comparing the highest temperature with measured temperatures of a plurality of adjacent measurement points of a measurement point corresponding to the highest temperature based on a position order of the plurality of adjacent measurement points of the measurement point corresponding to the highest temperature.

9. The method of claim 8, wherein the determining whether the fault occurs at the plurality of measurement points based on the result of the comparison comprises:
determining whether the fault occurs at the measurement point corresponding to the highest temperature based on the result of the comparison.

10. The method of claim 9, further comprising:
determining a working scene of the plurality of measurement points; and
determining a scene-specific temperature threshold based on the working scene.

11. The method of claim 10, wherein the comparing the highest temperature with measured temperatures of a plurality of adjacent measurement points of a measurement point corresponding to the highest temperature based on the position order of the plurality of adjacent measurement points of the measurement point corresponding to the highest temperature comprises:
determining whether the highest temperature satisfies a predetermined temperature relationship of the plurality of adjacent measurement points.

12. The method of claim 11, wherein the determining whether the fault occurs at the measurement point corresponding to the highest temperature based on the result of the comparison comprises:
determining that the measurement point corresponding to the highest temperature is normal when the highest temperature satisfies the predetermined temperature relationship of the plurality of adjacent measurement points; and
determining whether a difference between the highest temperature and the measured temperature of the previous adjacent measurement point is within a scene-specific temperature threshold when the highest temperature does not satisfy the predetermined temperature relationship of the plurality of adjacent measurement points.

13. The method of claim 12, wherein when the difference between the highest temperature and the measured temperature of the previous adjacent measurement point is within the scene-specific temperature threshold, it is determined that the measurement point corresponding to the highest temperature is normal, and
when the difference between the highest temperature and the measured temperature of the previous adjacent measurement point exceeds the scene-specific temperature threshold, it is determined that the fault occurs at the measurement point corresponding to the highest temperature.

14. The method of claim 13, wherein the working scene comprises one or more of a wall-penetrating scene, a non-ventilation scene and a ventilation scene, and
wherein a scene-specific temperature threshold of the wall-penetrating scene is higher than a scene-specific temperature threshold of the non-ventilation scene, and the scene-specific temperature threshold of the non-ventilation scene is higher than a scene-specific temperature threshold of the ventilation scene.

15. The method of claim 8, wherein the plurality of adjacent measurement points comprise a first plurality of previous measurement points and a second plurality of subsequent measurement points.

16. The method of claim 1, wherein determining whether the fault occurs at the plurality of measurement points does not require current signals of the plurality of measurement points.

17. A device for detecting a busway fault, comprising:
a memory; and
a processor coupled with the memory and configured to perform an operation, comprising:
obtaining a plurality of respective measured temperatures corresponding to a plurality of measurement points on a busway;
comparing the plurality of measured temperatures based on a position order of the plurality of measurement points; and
detecting that the busway fault occurs at a measurement point of the plurality of measurement points based on a result of the comparison.

18. A system for detecting a fault in a busway, comprising:
a plurality of sensors arranged at each measurement point of a busway and configured to measure a temperature of a corresponding measurement point;
a transceiver configured to transmit and receive signals;
a memory; and
a processor coupled with the plurality of sensors, the transceiver and the memory and configured to perform an operation, comprising:
obtaining a plurality of respective measured temperatures corresponding to a plurality of measurement points on a busway;
comparing the plurality of measured temperatures based on a position order of the plurality of measurement points; and
detecting that the fault occurs at a measurement point of the plurality of measurement points based on a result of the comparison.
